(19) United States
(12) Patent Application Publication
(10) Pub. No.: US 2023/0242764 A1
(43) Pub. Date: Aug. 3, 2023

(54) Fire Protection Material

(71) Applicant: Freudenberg-NOK General Partnership, Plymouth, MI (US)

(72) Inventors: Paul J. HOCHGESANG, Ann Arbor, MI (US); Michael Blake, Northville, MI (US)

(21) Appl. No.: 18/160,660

(22) Filed: Jan. 27, 2023

Related U.S. Application Data
(60) Provisional application No. 63/304,121, filed on Jan. 28, 2022.

(51) Int. Cl. C08L 83/04; C08K 3/22; C08K 3/04; H01M 50/227; H01M 50/229; H01M 50/222; H01M 50/233; H01M 50/293

(52) U.S. Cl. CPC C08L 83/04; C08K 3/22; C08K 3/04; H01M 50/227; H01M 50/229; H01M 50/222; H01M 50/233; H01M 50/293; C08K 2003/2227; C08L 2201/02; C08L 2205/16

(57) ABSTRACT

Fire protection materials comprising an endothermic hydrate, an intumescent, a heat resistant fiber and an elastomeric polymer. In various embodiments, endothermic hydrate comprises aluminum trihydrate, the intumescent comprises expandable graphite, and the heat resistant fiber comprises poly(p-phenylene terephthalamide). The elastomeric polymer may be a polyorganosiloxane, such as a phenyl substituted polydimethyl siloxane. Also described are structures comprising such fire protection materials, e.g., separators and other battery containment structures such as for use with high density lithium batteries.

### CROSS-REFERENCE TO RELATED APPLICATIONS

This application claims the benefit of U.S. Provisional Application No. 63/304,121, filed on Jan. 28, 2022. The entire disclosure of the above application is incorporated herein by reference.

### BACKGROUND

The present technology relates to compositions having fire protection properties, such as for use in structures that may be subjected to combustion. For example, such structures include battery containment structures.

Fire retardant or containment materials (“fire protection materials”) are useful in a variety of commercial applications. For example, such materials may be used in structures to prevent or reduce the combustion of the structure, or to contain combustion of adjacent materials such as materials housed or contained in the structure. Fire protection materials may be particularly useful in structures in critical systems, such as automotive or aerospace products, where fires can have catastrophic consequences. For example, fire protection materials may be used to contain combustion in high density battery systems (e.g., lithium ion batteries) used in automotive, aerospace or other products.

Structures containing fire protection materials can vary widely, and may require properties (e.g., sealing) in addition to fire containment or retardancy. However, such materials known in the art can present challenges in some applications, such as due to lack of flexibility or resilience. Further, such materials may present processability concerns, such as in being readily formed into structures that have complex shapes and profiles or requiring multiple processing steps. Accordingly, there is a need for fire protection materials that can be formed into a variety of shapes, such as by injection molding or extrusion, for use in containment and other structures.

### SUMMARY

The present technology provides fire protection materials. In various embodiments, such fire protection materials comprise an endothermic hydrate, an intumescent, a heat resistant fiber and an elastomeric polymer. In various embodiments, endothermic hydrate comprises aluminum trihydrate, the intumescent comprises expandable graphite, and the heat resistant fiber comprises poly(p-phenylene terephthalamide). In various embodiments, the elastomeric polymer is a polyorganosiloxane, such as a phenyl substituted polydimethyl siloxane.

The present technology also provides structures comprising fire protection materials of the present technology. Such structures include battery containment structures, such as for use with high density batteries.

### DRAWINGS

FIG. 1 is a diagram of an exemplary battery structure of the present technology.

FIG. 2 is a diagram of an exemplary battery structure of the present technology.

FIGS. 3A and 3B are diagrams of an exemplary battery structure of the present technology.

FIGS. 4A, 4B, 4C, 4D, 4E, 4F, 4G, 4H, and 4I are diagrams of exemplary seal structures of the present technology.

FIG. 5 is a diagram of an exemplary battery structure of the present technology.

It should be noted that the figures set forth herein are intended to exemplify the general characteristics of devices among those of the present technology, for the purpose of the description of certain embodiments. These figures may not precisely reflect the characteristics of any given embodiment, and are not necessarily intended to define or limit specific embodiments within the scope of this technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Detailed Description.

As discussed above, the present technology provides fire protection materials. In various embodiments, such materials are useful for forming structures in high density batteries, such as lithium batteries used in automotive and aerospace products.

Fire Protection Materials

In general, the present technology provides fire protection materials an elastomeric polymer composition comprising endothermic hydrate, intumescent, heat resistant fibers. As referred to herein, such “fire protection materials” include those described herein. In various embodiments, without limiting the scope or utility of the present technology, such materials have “fire protection” properties which may include one or more of fire retardancy and fire containment (e.g., by containing, blocking or redirecting flames) under the conditions of intended use, it being understood that such qualities may be relative to materials not having the composition of the fire protection materials of this technology.

### Elastomeric Polymer:

The compositions of the present technology comprise one or more elastomeric polymers, including such polymers as are known in the art. The selection of polymer may depend on the specific end-use application for the fire protection material composition. In various embodiments, elastomers include thermoset polymers (requiring vulcanization), but may also include thermoplastic elastomers.

Thermoset polymers among those useful herein are characterized by long polymer chains that are cross-linked during curing, i.e., vulcanizing. Elasticity of the polymers is derived from the ability of the long chains to reconfigure themselves to distribute an applied stress, returning to their original configuration when the stress is removed. Such elastomers may reversibly extend from 5-700%, depending on the specific material.

Two or more liquid components can be reacted to form a thermoset polymer. Examples of thermoset polymers include rubber elastic polymers such as styrene-butadiene rubbers, acrylonitrile-butadiene rubbers, and chloroprene rubbers; phenol resins; unsaturated polyester resins; epoxy resins; polysiloxane resins such as silicone elastomers and room-temperature curing type silicone rubbers; and polyurethane resins. In various embodiments, elastomeric polymers include thermoplastic materials capable of being crosslinked with the addition of a crosslinking agent and/or exposure to an appropriate energy source such as an electron beam.

In various embodiments, the elastomeric polymer comprises an organopolysiloxane elastomer. Such elastomers include methyl-, phenyl-, fluoro-, and vinyl-substituted polysiloxane rubbers, and combinations thereof, such as methyl polysiloxane rubbers (MQ), vinyl methyl polysiloxane rubbers (VMQ), phenyl methyl polysiloxane rubbers (PVMQ), phenyl methyl polysiloxane rubbers (PMQ), and fluorovinyl methyl polysiloxane rubbers (FVMQ). In some embodiments, silicone elastomers comprise phenyl-substituted siloxanes, methyl-substituted siloxanes, or combinations thereof. For example, a commercially available phenyl silicone useful herein is Xiameter RBB-2060, from The Dow Chemical Company. For example, a commercially available methyl silicone useful herein is Elastosil R401/30, from Wacker Chemie AG.

In various embodiments, organopolysiloxanes are crosslinked using a catalyst, such as a platinum or peroxide. Peroxides may be organic peroxides, such as di(2,4-dichlorobenzoyl) peroxide (commercially available as Perkadox® PD-50S-PS from Nouryon Functional Chemicals B.V.) and 2,5-dimethyl-2,5-di(t-butylperoxy) hexane (DBPH, commercially available as varox® DBPH, from Vanderbilt Chemicals, LLC).

### Endothermic Hydrate:

The compositions of the present technology comprise one or more endothermic hydrate material that releases water under heat. In various embodiments the endothermic hydrate is a mineral hydrate, comprising one or more water molecules bound to a metal ion. Examples include aluminum trihydrate, alumina trihydrate, aluminum potassium sulfate dodecahydrate, aluminum sulfate hexadecahydrate, aluminum potassium sulfate dodecahydrate, beryllium oxalate trihydrate, calcium chromate dihydrate, calcium ditartrate tetrahydrate, calcium carbonate dihydrate (gypsum), calcium hydroxide, manganese chloride tetrahydrate, magnesium antimonate hydrate, magnesium bromate hexahydrate, hydrated magnesium carbonate (e.g., magnesium carbonate trihydrate (nesquehonite)), magnesium chloride hexahydrate, magnesium hydroxide, hydrated magnesium hydroxide, magnesium iodate tetrahydrate, magnesium phosphate octahydrate, magnesium sulfate heptahydrate, potassium ruthenate hydrate, potassium sodium tartrate tetrahydrate, cobalt orthophosphate octahydrate, sodium aluminum carbonate hydroxide (dawsonite), sodium tetraborate decahydrate, sodium thiosulfate pentahydrate, sodium pyrophosphate hydrate, zirconium chloride octahydrate, thorium hypo phosphate hydrate, thallium sulfate heptahydrate, zinc iodate dihydrate, zinc sulfate heptahydrate, zinc phenol sulfonate octahydrate, and dysprosium sulfate octahydrate. In various embodiments, the endothermic hydrate material is selected from the group consisting of aluminum trihydrate, alumina trihydrate, calcium hydroxide, dawsonite, gypsum, hydrated magnesium hydroxide, hydrated magnesium carbonate, magnesium phosphate octahydrate, and mixtures thereof. In some embodiments, the endothermic hydrate comprises, or consists of, aluminum hydroxide or ATH (aluminum trihydrate or alumina trihydrate). For example, a commercially available surface treated ATH is Hymod® M9400-SP, from J. M. Huber Corporation.

### Intumescent

The compositions of the present technology comprise one more intumescent materials that, in some aspects, may increase in volume under heat. For example, the volume of such materials may expand by 50% or more (e.g., from about 15 to about 30 times) upon exposure to combustion. Such materials may form an ash-like material upon exposure to fire.

Examples of intumescent materials include alkali metal silicates, graphite (expandable graphite), vermiculite, perlite, ammonium phosphate, ammonium sulphate, boric acid, sodium borate, borax, and mixtures thereof. In some embodiments, intumescents comprise include hydrated alkali metal silicates, graphite such as intercalated graphite, expandable graphite (acid treated graphite), vermiculite, perlite, and mica. In some aspects the intumescent comprises, or consists of, expandable graphite, having has a structure consisting of carbon atoms bonded in hexagonal rings joined at their corners to form large planar arrays. For example, an expandable graphite useful herein is Expandable Graphite 3538 from Asbury Graphite Mills, Inc.

### Heat Resistant Fiber

The compositions of the present technology comprise one more heat resistant fiber materials. In various embodiments, heat resistant fibers comprises polyacrylonitrile fibers, meta-aramids, para-aramids, poly(diphenylether para-aramid), polybenzimidazole, polyimides, polyamideimides, novoloids, poly(p-phenylene benzobisoxazoles), poly(p-phenylene benzothiazoles), flame retardant viscose rayon, polyetheretherketones, polyketones, polyetherimides, glass fiber, mineral fiber, ceramic fiber, carbon fiber, stainless steel fiber and combinations thereof and combinations thereof. In some embodiments, the heat resistant fiber comprises a para-amide, such as poly(p-phenylene terephthalamide). For example, para-amide useful herein is commercially available as Kevlar®, from DuPont de Neumours, Inc., In some embodiments (e.g., certain batteries), the heat resistant fiber does not contain, or is substantially free (e.g., containing less than 1 phr, less than 0.5 phr, less than 0.01 phr, or less than 0.005 phr) polyacrylonitrile.

### Optional Components:

The compositions of the present technology may optionally comprise optional components to modify physical characteristics or improve processability. In various embodiments, such optional materials may include processing aids, plasticizers, fillers, and mixtures thereof. In various embodiments, compositions comprise fillers, such as silica (e.g., ground or platelet silica), clay, and calcium carbonate. In some embodiments, compositions comprise a quartz silica particulate. For example, a quartz silica particulate is available as Novacite® or Novakup® from Malvern Minerals Company.

Compositions may also comprise a plasticizer, such as a silicone fluid. Such plasticizers include polyphenylmethyldimethylsiloxane polymer fluid (such as Dowsil® 550, sold by The Dow Chemical Company) and phenyl methyl polysiloxane (such as RE-5530U, sold by Shin Etsu Chemical Co., Ltd.).

### Formulations:

In general, the fire protection compositions of the present technology comprise a mixture (e.g., a blend) of an endothermic hydrate, an intumescent, a heat resistant fiber and an elastomeric polymer. The various amounts of materials in the present technology may be expressed in parts per hundred rubber (PHR or PPHR) by weight, as understood by one of ordinary skill in the art. Thus, as expressed herein, the elastomeric polymer of any given composition constitutes 100 phr as a base material, relative to which the levels of other components are defined. For compositions wherein the elastomeric polymer comprises two or more polymers, the phr levels of the individual polymers total 100 (i.e., the level of all polymer components total 100% by weight of the elastomeric component). The level of additional components are defined as phr relative to the base material.

For example, in various embodiments, compositions comprising two or more elastomeric components, each component may be present at a level of at about 5 phr, at least about 10 phr, at least about 15 phr, at least about 20 phr, at least about 25 phr, at least about 30 phr, at least about 35 phr, at least about 40 phr, at least about 45 phr, 50 phr, at least about 55 phr, at least about 60 phr, at least about 65 phr, at least about 70 phr, at least about 75 phr, at least about 80 phr, at least about 85 phr, at least about 90 phr, or at least about 95 phr. Expressed as a percent by weight of the fire protection composition, the elastomeric component (as a base material, comprising one or more elastomers) may be present in various embodiments, at a level of at least about 30%, at least about 35%, at least about 40%, at least about 45%, at least about 50%, at least about 55%, at least about 60%, at least about 65%, at least about 70%, at least about 75%, at least about 80%, or at least about 85%. In various embodiments, the elastomeric component may be present at a level of 90% or less, 85% or less, 80% or less, 75% or less, 70% or less, 65% or less, 60% or less, 55% or less, 50% or less, 45% or less, 40% or less, 35% or less, or 30% or less.

In various embodiments, compositions comprise at least about 20%, at least about 25%, at least about 28%, at least about 30%, at least about 35%, or at least about 40%, of the endothermic hydrate. Compositions may comprise at least about 40 phr, at least about 45 phr, at least about 50 phr, at least about 55 phr, or at least about 60 phr of endothermic hydrate. Compositions may comprise 80 phr or less, 75 phr or less, 70 phr or less, 65 phr or less, or 60 phr or less of endothermic hydrate. In some embodiments, the endothermic hydrate is present at a level of from about 40 phr to about 75 phr, preferably from about 55 phr to about 65 phr.

In various embodiments, compositions comprise at least about 0.5 phr, at least about 1 phr, at least about 2 phr, at least about 4 phr, at least about 5 phr, at least about 6 phr of intumescent material. Compositions may comprise 25 phr or less, 20 phr or less, 15 phr or less, or 10 phr or less, 8 phr or less, or 7 phr or less of intumescent material. In some embodiments, the intumescent material is present at a level of from about 1 phr to about 20 phr, preferably from about 2 phr to about 10 phr.

In various embodiments, compositions comprise at least about 1 phr, at least about 2 phr, at least about 4 phr, at least about 5 phr, at least about 6 phr, at least about 7 phr of heat resistant fiber. Compositions may comprise 25 phr or less, 20 phr or less, 15 phr or less, or 10 phr or less, or 9 phr or less of heat resistant fiber. In some embodiments, the heat resistant fiber is present at a level of from about 5 phr to about 20 phr, preferably from about 6 phr to about 10 phr.

In various embodiments, compositions comprise optional materials, such as fillers, at a level of at least about 0.1 phr, at least about 0.5 phr, at least about 1 phr, at least about 2 phr, at least about 5 phr, or at least about 10 phr. Compositions may comprise 25 phr or less, 20 phr or less, 15 phr or less, or 10 phr or less, 8 phr or less, or 7 phr or less of optional material. In some embodiments, the optional material is present at a level of from about 1 phr to about 20 phr, preferably from about 2 phr to about 10 phr.

For example, the present technology provides a fire protection material comprise from about 40% to about 55% by weight of elastomeric polymer, and:

from about 40 phr to about 75 phr of a metal hydrate;

from about 1 phr to about 20 phr of an intumescent;

from about 5 phr to about 20 phr of a heat resistant fiber; and

from about 0 phr to about 15 phr of an optional material (e.g., a filler).

In one embodiment, a fire protection material comprises from about 50% to about 55% of elastomeric polymer, and:

from about 55 phr to about 60 phr (e.g., about 59 phr) of a metal hydrate;

from about 5 phr to about 10 phr (e.g., about 7 phr) of an intumescent;

from about 7 phr to about 10 phr (e.g., about 8 phr) of a heat resistant fiber; and

optionally, from about 2 phr to about 4 phr of a filler.

Structures and Methods of Manufacturing

In general, such compositions may be made by methods among those known in the art for making elastomeric compositions. For example, compositions may be made by mixing using dough type mixers and open two roll mills.

Fire protection materials of the present technology may be used to make a wide variety of structures. Advantageously relative to materials and constructs for containing or retarding fire among those known in the art, structures may be made by extrusion, compression molding, calendaring, or injection molding of the fire protection materials of the present technology. In various aspects, such methods afford ease of processing, and flexibility in the design of structures, e.g., allowing for the formation of complex shapes and structures compared to (for example) structures that comprise layers of materials. In various aspects, structures of the present technology are homogenous, not having layers or regions having differing compositions (e.g., lacking endothermic hydrate, intumescent, or heat resistant fiber components).

Accordingly, the present technology provides structures comprising fire protection materials, particularly including structures which may be subjected to heat and other products of combustion. Combustion may include fires or any chemical reaction that create elevated temperature that present risk of fire or failure of the structure. electrical devices. Such temperature may exceed 300° C., 500° C., 800° C., 1200° C., 1500° C., 2000° C., 2500° C. or more. In various embodiments, the materials and structures of the present technology are capable of withstanding flame exposure of at least about 1200° C. for at least about ten minutes (ten minutes or more).

As noted above, “fire protection” properties may include one or more of fire retardancy and fire containment under the conditions of intended use. As will be understood by one of ordinary skill in the art, compositions may be formulated and manufactured in a manner suitable for the intended use, balancing relevant properties and manufacturing considerations including cost of materials, processability, the intended form and physical parameters of the structure comprising the material, and expected specific combustion risks. It is also understood that specific “fire protection” attributes are relative to materials not having the composition of the fire protection materials of this technology, and that any material may be subject to combustion or other degradation under extreme conditions.

In some embodiments, structures of the present technology are sealing structures, formed or used between the surfaces of two component structures. Such sealing structures may be used in a wide variety of applications, including in batteries, engines, motors and other devices where combustion or elevated temperatures are of concern. Such seals may require reduced sealing force relative to seals comprising fire protection materials among those known in the art (e.g., seals comprising fabric layers).

In some embodiments, structures of the present technology comprise or are components of batteries, particularly high density batteries, i.e., a battery having a high energy density (energy generated or stored per volume or mass). For example, such batteries may include primary or secondary batteries, having any of a variety of anode and cathode chemistries among those known in the art. In various embodiments, batteries may be lithium batteries, including lithium ion batteries. As is understood in the art, under some circumstances, lithium ion batteries may be degraded resulting in one or more of mechanical failure, thermal failure or internal electrical shorts producing extremely high temperatures, e.g., 1800° C., 2000° C., 2200° C. or more (thermal runaway). Conditions of thermal runaway are discussed in ECE-Global Technical Regulation 20, Section 23B.3.3. Such temperatures, if not contained, can lead to failure (thermal runaway) of adjacent battery cells, failure (combustion) of battery structures, and combustion of structures adjacent to the battery. The fire protection materials of the present technology may be used to form sealing or containment structures that will, in various embodiments, withstand such temperatures or contain such temperatures and products of combustion to protect adjacent materials and structures. Such structures may include, for example, partition panels or barriers between modules comprising one or more battery cells, seals between panels and housing or compartment walls (e.g., flame barrier profile seals), flame barrier mats (e.g., for use in housing covers), thermal barriers over cooling tubes or structures, caps or other structures covering or otherwise providing arc protection for busbars (e.g., over-molded busbars), and battery covers, containers or housings, and components thereof. As will be appreciated by one of skill in the art, without limiting the scope or utility of the present technology, such protection may be particularly advantageous in transportation vehicle systems, such as in the automotive (e.g., cars and trucks), agricultural (e.g., tractors and combines), marine (e.g., ships and boats), and aerospace industries (airplanes, rockets, satellites, and manned or unmanned space vehicles), where combustion can result in failure of critical systems and destruction of the vehicle and potential loss of life. Materials and compositions may be useful in other structures, including buildings (commercial and residential), electronic devices, and energy storage and transmission systems.

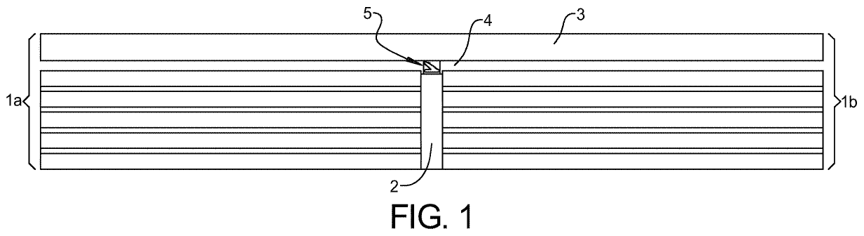

Exemplary embodiments of battery structures are depicted in FIGS. 1, 2, 3, and 5. In FIG. 1, two five-cell battery modules (1a, 1b) are shown, separated by a barrier (2). The modules are proximate to a battery case (3). In some embodiments the case (3) may be a separator between the battery modules (1a, 1b) and adjacent cell modules (not shown). The case and battery modules (1a, 1b) define a passage (4), in which a lip seal (5) is disposed. The lip seal (5) may seal or contain combustion products (flame, gasses) between the battery modules (1a and 1b). In some embodiments, any or all of the barrier (2), the battery case (3) and lip seal (5) are formed from the fire protection materials of the present technology.

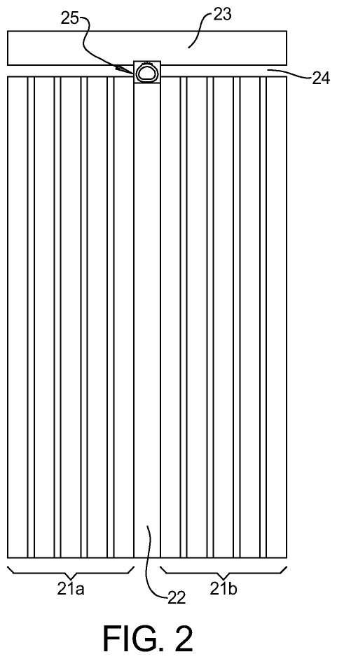

In FIG. 2, two five-cell battery modules (21a, 21b) are shown, separated by a barrier (22). The modules are proximate to a battery case (23). In some embodiments the case (23) may be a separator between the battery modules (21a, 21b) and adjacent cell modules (not shown). The case and battery modules (21a, 21b) define a passage (24), in which a bulb seal (25) is disposed. The bulb seal (25) may seal or contain combustion products (flame, gasses) between the battery modules (21a and 21b). In some embodiments, any or all of the barrier (22), the battery case (23) and bulb seal (25) are formed from the fire protection materials of the present technology.

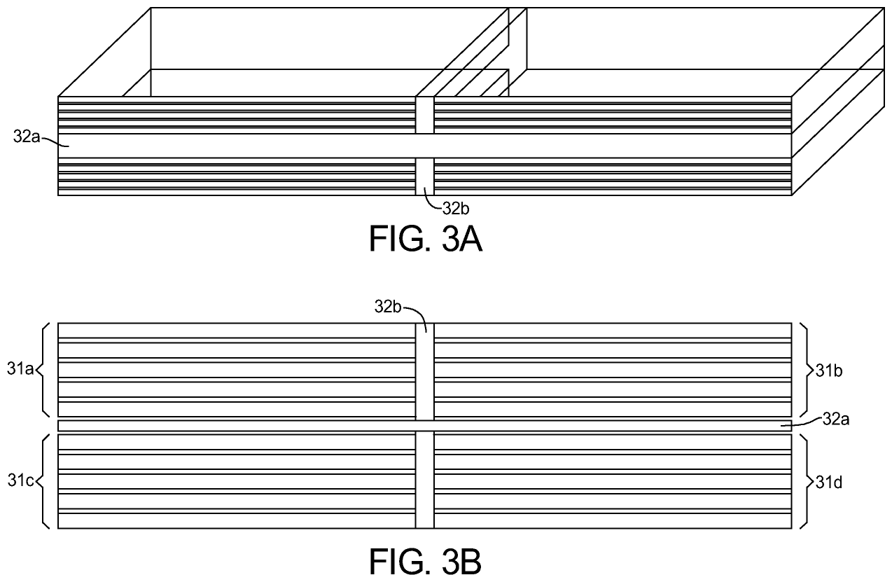

In FIGS. 3A and 3B, four five-cell battery modules (31a, 31b, 31c and 31d) are shown, separated by separators (i.e., barriers) (32a, 32b). The modules are proximate to a battery case (not shown). In some embodiments the case may be a separator between one or more of battery modules 31a and 31b and adjacent cell modules (not shown), between battery modules 31c and 31d and adjacent cell modules (not shown), between battery modules 31a and 31c and adjacent battery modules (not shown), and between battery modules 31b and 31d and adjacent battery modules (not shown). The case (not shown) and one or more of battery modules 31a and 31b, battery modules 31c and 31d, battery modules 31a and 31c, and battery modules 31b and 31d may define a passage (not shown), in which a seal (not shown) is disposed. The seal may contain combustion products (flame, gasses) between adjacent battery modules (e.g., between modules 31a and 31b, between 31a and 31c, between 31b and 31d, and between 31c and 31d), in a manor analogous to the disposition of seal (25) in a passage (24) between the case (23) and battery modules 21a and 21b depicted in FIG. 2. In various embodiments, any or all of the separators (32a, 32b), the battery case, and seals are formed from the fire protection materials of the present technology.

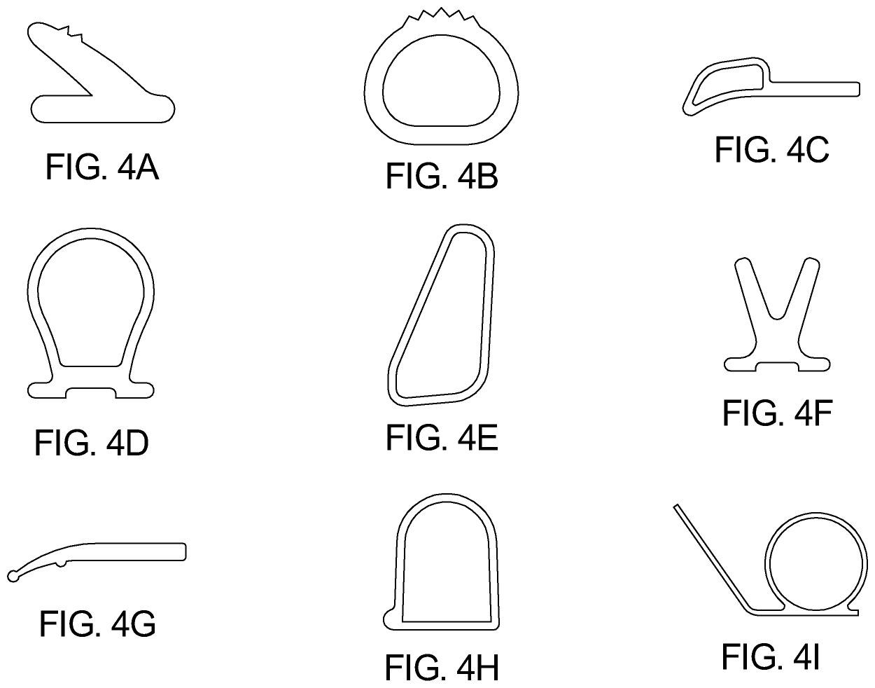

FIGS. 4A, 4B, 4C, 4D, 4E, 4F, 4G, 4H, and 4I depict various seal embodiments of the present technology, which may be used (for example) in battery structures. FIG. 4A is a diagram of an exemplary lip seal. The lip seal can face left or right, and may have multiple sealing lips. FIG. 4B is a diagram of an exemplary bulb seal. FIG. 4C is a diagram of an exemplary seal comprising bulb seal and lip seal elements. FIG. 4D is a diagram of another exemplary bulb seal. FIG. 4E is a diagram of yet another exemplary bulb seal. FIG. 4F is a diagram of another exemplary lip seal. FIG. 4G is a diagram of yet another exemplary lip seal. FIG. 4H is a diagram of a yet another exemplary bulb seal embodiment. FIG. 4I is a diagram of another exemplary seal comprising a bulb seal and lip seal elements. In various embodiments, lip seals and bulb seals may be low pressure sealing elements. The cross sections of both the lip seal and the bulb seal may be designed based on the specific end-use application. For example, the lip seal can have a single lip or multiple lips. The sealing lip can be folding to the left or right or sealing lips facing left and right. Also, for example, the cross sectional thickness of the seals may be designed for the specific end-use (e.g., battery) applications.

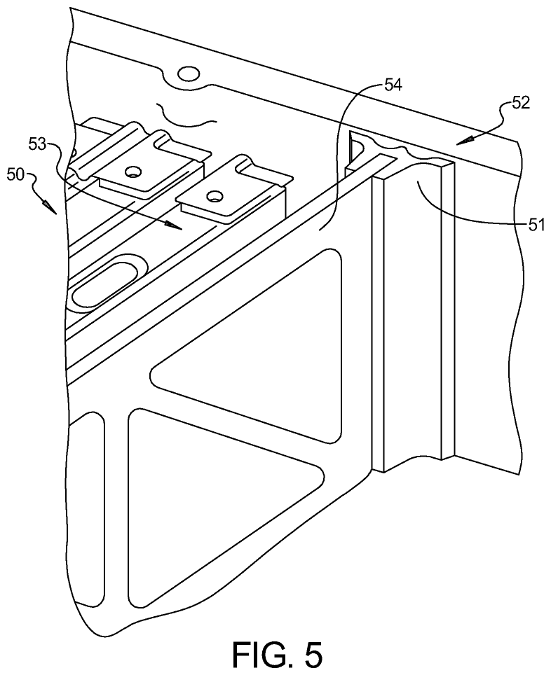

FIG. 5 depicts a cut-away view of a portion of a battery system (e.g., a lithium cell battery array) comprising seals and other structures of the present technology. In particular, the battery system (50) comprises an array of prismatic battery cells (53) (e.g., lithium batteries) in a housing or compartment (52). Adjacent arrays of cells (53) are separated by partition panel (54). A flame barrier seal (51) forms a seal between the end of a partition panel (54) and a wall of the housing (52). In some embodiments, any or all of the housing (52), partition panels (54) and flame barrier seals (51) are formed from the fire protection materials of the present technology.

### Non-Limiting Listing of Exemplary Embodiments

The present technology includes the following exemplary embodiments.

A1 A fire protection elastomer composition comprising an mixture of:

an endothermic hydrate;

an intumescent;

a heat resistant fiber; and

an elastomeric polymer.

A2. The fire protection material of Embodiment A1, wherein the endothermic hydrate is selected from the group consisting of aluminum trihydrate, alumina trihydrate, aluminum sulfate hexadecahydrate, aluminum potassium sulfate dodecahydrate, magnesium sulfate heptahydrate, magnesium chloride hexahydrate, and sodium tetraborate decahydrate, and mixtures thereof.
A3. The fire protection material of Embodiment A2, wherein the endothermic hydrate comprises aluminum trihydrate, alumina trihydrate, or mixtures thereof.
A4. The fire protection material of Embodiment A2 or Embodiment A3, wherein the endothermic hydrate is present at a level of from about 40 phr to about 75 phr, preferably from about 55 phr to about 65 phr.
A5. The fire material of any one of Embodiments A1-A4, wherein the intumescent is selected from the group consisting of alkali metal silicates, graphite, vermiculite, perlite, ammonium phosphate, ammonium sulphate, boric acid, sodium borate, borax and mixtures thereof.
A6. The fire protection material of Embodiment A5, wherein the intumescent comprises expandable graphite.
A7. The fire protection material of any one of Embodiments A1-A6, wherein the intumescent is present at a level of from about 1 phr to about 20 phr, preferably from about 2 phr to about 10 phr.
A8. The fire protection material of any one of Embodiments A1-A7, wherein the heat resistant fiber comprises meta-aramids, para-aramids, poly(diphenylether para-aramid), polybenzimidazole, polyimides, polyamideimides, novoloids, poly(p-phenylene benzobisoxazoles), poly(p-phenylene benzothiazoles), polyacryulonitriles, flame retardant viscose rayon, polyetheretherketones, polyketones, polyetherimides, and combinations thereof.
A9. The fire protection material of Embodiment A8, wherein the heat resistant fiber comprises poly(p-phenylene terephthalamide).
A10. The fire protection material of any one of Embodiments A1-A9, which is substantially free of polyacrylonitrile fibers.
A11. The fire protection material of any one of Embodiments A1-A10, wherein the heat resistant fiber is present at a level of from about 5 phr to about 20 phr, preferably from about 6 phr to about 10 phr.
A12. The fire protection material of any one of Embodiments A1-A11, wherein the elastomeric polymer is a polyorganosiloxane.
A13. The fire protection material of Embodiment A12, wherein the polyorganosiloxane comprises a phenyl substituted polydimethyl siloxane.
A14. The fire protection material of any one of Embodiments A1-A13, wherein the elastomeric polymer is present at a level of from about 40% to about 55%.
A15. The fire protection material of any one of Embodiments A1-A14, further comprising a filler, preferably present at a level of from about 1 phr to about 15 phr.
A16. The fire protection material of Embodiment A15, wherein the filler comprises a quartz silica.
A17. The fire protection material of any one of Embodiments A1-A16, wherein the material is capable of withstanding flame exposure of at least about 1200° C. for at least about ten minutes.
B1. A fire protection structure, formed of polymer comprising from about 50% to about 55% of elastomeric polymer and:

from about 40 phr to about 75 phr of a metal hydrate;

from about 1 phr to about 20 phr of an intumescent; and

from about 5 phr to about 20 phr of a heat resistant fiber.

B2. The fire protection structure of Embodiment B1, wherein the metal hydrate comprises aluminum trihydrate, alumina trihydrate, or mixtures thereof.
B3. The fire protection structure of Embodiment B1 or Embodiment B2, wherein the intumescent comprises expandable graphite.
B4. The fire protection structure of any one of Embodiments B1-B3, wherein the heat resistant fiber comprises poly(p-phenylene terephthalamide).
B5. The fire protection structure of any one of Embodiments B1-B4, wherein the elastomeric polymer comprises a phenyl substituted polydimethyl siloxane.
B6. The fire protection structure of any one of Embodiments B1-B5, wherein the polymer is essentially free of polyacrylonitrile fibers.
B7. The fire protection material of any one of Embodiments B1-B6, wherein the material is capable of withstanding flame exposure of at least about 1200° C. for at least about ten minutes.
B8. A battery structure comprising a fire protection material according to any one of Embodiments B1-B7.
B9. The battery structure of Embodiment B8, wherein the structure is a component of a lithium battery.
B10. A fire protection structure of Embodiment B9, wherein the component is a partition panel, a seal between a panel or compartment wall, (e.g., flame barrier profile seals), a flame barrier mat (e.g., for use in housing covers), a thermal barriers over a cooling structure, a structures providing arc protection for busbars (e.g., over-molded busbars), a battery covers, containers or housings, and components thereof.
B11. The battery structure according to Embodiment one of Embodiments B8-B10, wherein the structure is formed by extrusion, injection molding, calendaring, or compression molding.
C1. A fire protection structure comprising a fire protection material of any one of Embodiments A1-A17 or any one of Embodiments B1-B7.
C2. A fire protection structure of Claim C1, wherein the structure is a component of a lithium battery system comprising a plurality of lithium battery cell arrays, a housing, a cover, partitions disposed between cell arrays, cooling structures, and busbars.
C3. A fire protection structure of Embodiment C2, wherein the structure is a partition panel, a seal between a panel or compartment wall, (e.g., flame barrier profile seals), a flame barrier mat (e.g., for use in housing covers), a thermal barriers over a cooling structure, a structures providing arc protection for busbars (e.g., over-molded busbars), a battery covers, containers or housings, and components thereof.
D1. The fire protection structure comprising a homogenous composition according to any one of Embodiments A1-A17.
D2. The fire protection structure according to Embodiment D1, wherein the structure is formed by extrusion, injection molding, calendaring, or compression molding.

Non-limiting Discussion of Terminology

The foregoing description is merely illustrative in nature and is in no way intended to limit the technology, its application, or uses. The broad teachings of the technology can be implemented in a variety of forms. Therefore, while this technology includes particular examples, the true scope of the technology should not be so limited since other modifications will become apparent upon a study of the drawings, the specification, and the following claims.

The headings (such as “Background” and “Summary”) and sub-headings used herein are intended only for general organization of topics within the present technology, and are not intended to limit the technology of the technology or any aspect thereof. In particular, subject matter disclosed in the “Background” may include novel technology and may not constitute a recitation of prior art. Subject matter disclosed in the “Summary” is not an exhaustive or complete technology of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

It should be understood that one or more steps within a method may be executed in different order (or concurrently) without altering the principles of the present technology. Further, although each of the embodiments is described above as having certain features, any one or more of those features described with respect to any embodiment of the technology can be implemented in and/or combined with features of any of the other embodiments, even if that combination is not explicitly described. In other words, the described embodiments are not mutually exclusive, and permutations of one or more embodiments with one another remain within the scope of this technology. For example, a component which may be A, B, C, D or E, or combinations thereof, may also be defined, in some embodiments, to be A, B, C, or combinations thereof.

As used herein, the phrase at least one of A, B, and C should be construed to mean a logical (A or B or C), using a non-exclusive logical OR, and should not be construed to mean “at least one of A, at least one of B, and at least one of C.”

As used herein, the words “prefer” or “preferable” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein. Further, as used herein the term “consisting essentially of” recited materials or components envisions embodiments “consisting of” the recited materials or components.

“A” and “an” as used herein indicate “at least one” of the item is present; a plurality of such items may be present, when possible.

Unless specified otherwise, all percentages herein are by weight.

Numeric values stated herein should be understood to be approximate, and interpreted to be about the stated value, whether or not the value is modified using the word “about.” Thus, for example, a statement that a parameter may have value “of X” should be interpreted to mean that the parameter may have a value of “about X.” The term “about” indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates variations that may arise from ordinary methods of manufacturing, measuring or using the material, device or other object to which the calculation or measurement applies.

As referred to herein, ranges are, unless specified otherwise, inclusive of endpoints and include technology of all distinct values and further divided ranges within the entire range. Thus, for example, a range of “from A to B” or “from about A to about B” is inclusive of A and of B. Further, the phrase “from about A to about B” includes variations in the values of A and B, which may be slightly less than A and slightly greater than B; the phrase may be read be “about A, from A to B, and about B.” Technology of values and ranges of values for specific parameters (such as temperatures, molecular weights, weight percentages, etc.) are not exclusive of other values and ranges of values useful herein.

It is also envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that technology of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

What is claimed is:

1. A fire protection elastomer composition comprising an mixture of:
an endothermic hydrate;
an intumescent;
a heat resistant fiber; and
an elastomeric polymer.

2. The fire protection material of claim 1, wherein the endothermic hydrate is selected from the group consisting of aluminum trihydrate, alumina trihydrate, aluminum sulfate hexadecahydrate, aluminum potassium sulfate dodecahydrate, magnesium sulfate heptahydrate, magnesium chloride hexahydrate, and sodium tetraborate decahydrate, and mixtures thereof.

3. The fire protection material of claim 2, wherein the endothermic hydrate comprises aluminum trihydrate, alumina trihydrate, or mixtures thereof.

4. The fire protection material of claim 1, wherein the endothermic hydrate is present at a level of from about 40 phr to about 75 phr, preferably from about 55 phr to about 65 phr.

5. The fire material of claim 1, wherein the intumescent is selected from the group consisting of alkali metal silicates, graphite, vermiculite, perlite, ammonium phosphate, ammonium sulphate, boric acid, sodium borate, borax and mixtures thereof.

6. The fire protection material of claim 5, wherein the intumescent comprises expandable graphite.

7. The fire protection material of claim 1, wherein the heat resistant fiber comprises meta-aramids, para-aramids, poly(diphenylether para-aramid), polybenzimidazole, polyimides, polyamideimides, novoloids, poly(p-phenylene benzobisoxazoles), poly(p-phenylene benzothiazoles), polyacryulonitriles, flame retardant viscose rayon, polyetheretherketones, polyketones, polyetherimides, and combinations thereof.

8. The fire protection material of claim 7, wherein the heat resistant fiber comprises poly(p-phenylene terephthalamide).

9. The fire protection material of claim 1, which is substantially free of polyacrylonitrile fibers.

10. The fire protection material of claim 1, wherein the elastomeric polymer is a polyorganosiloxane.

11. The fire protection material of claim 1, wherein the material is capable of withstanding flame exposure of at least about 1200° C. for at least about ten minutes.

12. A fire protection structure, comprising a fire protection material of claim 1.

13. A fire protection structure of claim 12, wherein the structure is a component of a lithium battery.

14. A fire protection structure, formed of polymer comprising from about 50% to about 55% of elastomeric polymer and:
from about 40 phr to about 75 phr of a metal hydrate;
from about 1 phr to about 20 phr of an intumescent; and
from about 5 phr to about 20 phr of a heat resistant fiber.

15. The fire protection structure of claim 14, wherein the metal hydrate comprises aluminum trihydrate, alumina trihydrate, or mixtures thereof.

16. The fire protection structure of claim 14, wherein the intumescent comprises expandable graphite.

17. The fire protection structure of claim 14, wherein the heat resistant fiber comprises poly(p-phenylene terephthalamide).

18. The fire protection structure of claim 14, wherein the elastomeric polymer comprises a phenyl substituted polydimethyl siloxane.

19. The fire protection structure of claim 14, wherein the polymer is essentially free of polyacrylonitrile fibers.

20. A battery component comprising a fire protection structure of claim 14.
